(19) United States
(12) Patent Application Publication
(10) Pub. No.: US 2005/0278407 A1
(43) Pub. Date: Dec. 15, 2005

(54) Addressing type of asynchronous divider

(75) Inventor: Di Tang, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 11/139,647

(22) Filed: May 31, 2005

(30) Foreign Application Priority Data
Jun. 15, 2004 (TW) 093117166

(51) Int. Cl. G06F 7/52

(52) U.S. Cl. 708/650

(57) ABSTRACT

The present invention relates to an addressing type of asynchronous divider that uses addressing system, which enables an external circuit to receive a divisor and a dividend. Through the process of addressing type of asynchronous divider, the calculated quotient and remainder are transferred to the external circuit using addressing system. The addressing system of transferring can effectively make use of a memory and economize the design of a circuit, which can enhance the integration of a circuit.

### BACKGROUND OF THE INVENTION

1. Field of the Invention

The present invention relates to an asynchronous divider circuit, and more particularly, to an addressing type of asynchronous divider.

2. Description of Related Art

A central processing unit (CPU) comprises the following components: a control unit, arithmetic and logic units (ALU), and registers; the control unit coordinates and directs the transfers and operations of data between the various units of CPU, which helps the CPU to carry out instructions; the ALUs comprises arithmetic and logic units, which can respectively execute arithmetic operations (such as addition, subtraction, multiplication, division) and logic operations (such as AND, OR, NOT), and the calculated results are outputted to the registers. The ALUs comprise dividers, and when the CPU received instructions, it sifts out division instructions and division parameters for the divider to perform operations; then, the results from the divider are outputted. Because the address of the divider is set by the CPU, the resource of the CPU is wasted and its efficiency is affected.

### SUMMARY OF THE INVENTION

The main purpose of the present invention is to provide an addressing type of asynchronous divider, which takes advantages of addressing to control inputs and outputs of data. As a result, the space of the memory can be used effectively, and the cost for extra memories can be saved.

The other purpose of the present invention is to provide an addressing type of asynchronous divider, which takes advantages of addressing to control inputs and outputs of the data in order to enhance the integration of the circuit.

The present invention provides an addressing type of asynchronous divider that designates one hard drive address to execute operations, receiving a divisor and a dividend of the addressing inputs from an external circuit and outputting a quotient and a remainder to the external circuit. The addressing type of asynchronous divider of the present invention comprises as follows: a bus; a data acquisition controller, which connects to the bus in order to get the data and the address inputted through the bus; a plurality of pin that control the input/output status of the addressing type of asynchronous divider; an addressing type of input registers, which stores and outputs the divisor and the dividend inputted from the external circuit; a subtractor, which receives the divisor and the dividend inputted from the addressing type of input registers, in order to process the operations; a shift circuit, which shifts the changed unit of the dividend after the division process and then the shifted dividend is calculated again; and an addressing type of output registers, which receives the inputted quotient and remainder from such registers and then outputs to the external circuit using addressing system. The aforesaid shift circuit comprises: a register that saves the calculating results of the subtractor before outputting; and a counter that according to the unit operation of divider, every time the divider executes an operation, the counter will decrease by one. When the counter reaches a threshold limit value, the register will output the quotient and the remainder from the operation of the divider.

The aforesaid plurality of pin includes ALE pin, NWR pin, and NRD pin, which collocates with the data transferred from the bus to control the inputs and outputs of data.

### BRIEF DESCRIPTION OF THE DRAWINGS

FIG. 1 is a block diagram of the functionality of the preferred embodiment in accordance with the present invention.

### DETAILED DESCRIPTION OF THE PREFERRED EMBODIMENT

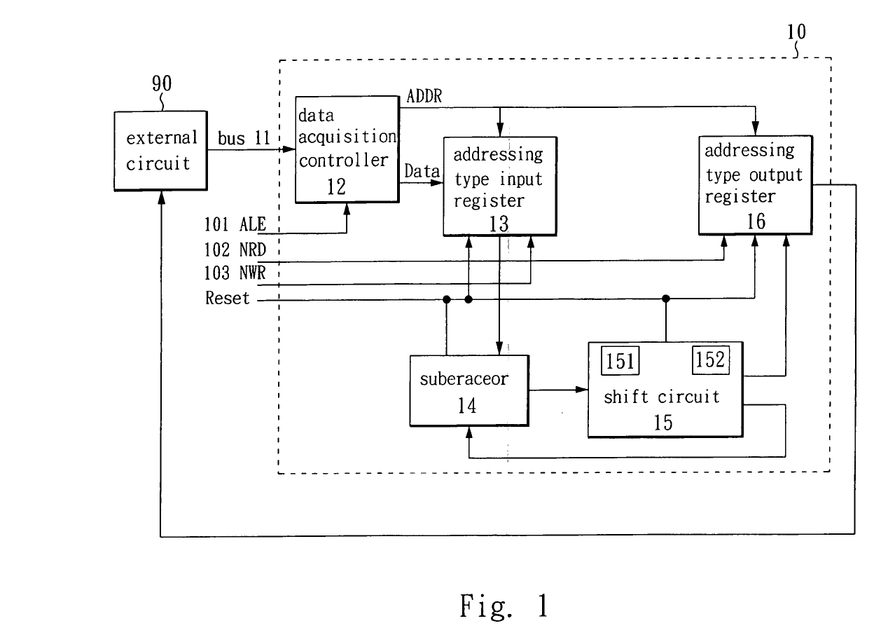

FIG. 1 is a block diagram of the functionality of an addressing type of asynchronous divider in accordance with the present invention, which comprises: a bus 11, a data acquisition controller 12, an ALE pin 101, an NRD pin 102, an NWR pin 103, an addressing type of input register 13, a subtractor 14, a shift circuit 15, and an addressing type of output register 16. The aforesaid bus 11 is the common type, which is compatible with the address bus and the data bus. The aforesaid data acquisition controller 12 is connected to the bus 11, in order to get the inputted data and address from the bus. The aforesaid ALE pin 101, NRD pin 102, and NWR pin 103 are used for controlling the input/output status of the addressing type of asynchronous divider 10. The aforesaid addressing type of input register 13 is used for storing the divisors and the dividends inputted from the external circuit 90. The aforesaid subtractor 14 receives the divisors and the dividends outputted from the addressing type of input register 13. Through the division process of the subtractor 14, the aforesaid shift circuit 15 transfers the changed unit of the dividend; then, the shifted dividend is sent to the divider 14 to be calculated again, wherein the shift circuit 15 comprises a register 151 and a counter 152. The aforesaid addressing type of output register 16 receives the quotient and the remainder from the register 151.

In the present invention, the data inputting/outputting through the bus 11 is in the form of a package which has an address and data, wherein the address of the aforesaid package is comparing to ALE pin 101, NRD pin 102, or NWR pin 103; for example, if the address of the package matches with the address of a pin, the data of the aforesaid package can be inputted or outputted.

The hard drive address of the addressing type of asynchronous divider 10 can be set by the user, and such self-set address is stored in the register (not shown). When the external circuit 90 output an address signal, if the hard drive address of this address signal matches the hard drive address of the addressing type of asynchronous divider 10, the addressing type of asynchronous divider 10 becomes active and begins to receive the data from the bus 11. The addressing type of asynchronous divider 10 has a 16-bit division capability, and the bandwidth of the bus 11 is 8-bit; thus, two 8-bit of data are needed to proceed to the operation. Through the bus 11, the addressing type of asynchronous divider 10 receives the divisor and the dividend from the external circuit 90, and output the calculated quotient and remainder to the external circuit 90.

As shown in FIG. 1, before proceeding to calculate, the addressing type of asynchronous divider 10 should be reset first, in order to assure the accuracy of the data. Through the bus 11, when the external circuit 90 transfers data to the addressing type of asynchronous divider 10, the data acquisition controller 12 will separate the data from the bus 11 into two categories: address and data which includes divisors and dividends. Depending on the designated address and the cooperated NRW pin 103, the divisor and the dividend will be sent to the addressing type input registers 13 to be operated. When the subtractor 14 is ready to operate, the addressing type input register 13 will input the divisor and the dividend to the subtractor 14. Because the addressing type of asynchronous divider 10 of the present invention is 16-bit, n−1 of 0 should be added to the dividend (where n is the bit number of the divider) before the operation, in order to have preferable results. At this point, the subtractor 14 calculates the operation of the dividend minus the divisor. The remainder of the subtraction replaces the dividend and is outputted to the register 151 of the shift circuit 15. If the new dividend is bigger than the divisor, the subtractor 14 will output “1” to the register 151; on the contrary, if the new dividend is smaller than the divisor, the subtractor 14 will output “0” to the register 151. Then, the register 151 will combine the results to form a quotient. When the subtractor 14 transfers the operated outcome to the register 151, the shift circuit 15 will move the dividend to the right next bit and combine the remainder to form a new dividend. The counter 152 of the shift circuit 15 will decrease by one, and the initial value of the counter 152 is in accordance with the operating bit of the addressing type of asynchronous divider 10. When the value of counter 152 reaches zero, which means the subtractor 14 finished the operation, the register 151 will output the quotient and remainder to the addressing type output register 16. Moreover, depending on the designated address and the cooperated NRD pin 103, the addressing type of output register 16 will transfer the quotient and remainder to the external circuit 90.

Although the present invention has been explained in relation to its preferred embodiment, it is to be understood that many other possible modifications and variations can be made without departing from the spirit and scope of the invention as hereinafter claimed.

1. An addressing type of asynchronous divider, which allocates one hard drive address to execute operations, receiving a divisor and a dividend of addressing inputs from an external circuit and outputting a quotient and a remainder to said external circuit; said circuit comprises:
a bus;
a data acquisition controller, which is connected to said bus in order to get the address and data that are inputted by said bus;
a plurality of pin, which controls the input/output status of the data of said addressing type of asynchronous divider;
an addressing type of input registers, which stores and then outputs said divisor and said dividend inputted from said external circuit;
a subtractor, which receives said divisor and said dividend inputted from said addressing type of input registers, in order to process the operation;
a shift circuit, which transfers a changed unit of said dividend after said division operation, and said shifted dividend is sent to said divider to be calculated again, said shift circuit comprises:
a register that stores the calculating results of said subtractor before transferring; and
a counter, according to the unit operation of said divider, every time said divider executes an operation, said counter will decrease by one;
when said counter reaches a threshold limit value, said register will output a quotient and a remainder from said operation of said divider;
an addressing type of output registers, which receives said inputted quotient and remainder from said output registers and then outputs to external circuit using addressing system.

2. The addressing type of asynchronous divider as claimed in claim 1, wherein said threshold limit value of said counter is zero.

3. The addressing type of asynchronous divider as claimed in claim 1, wherein said pin is an ALE pin.

4. The addressing type of asynchronous divider as claimed in claim 1, wherein said pin is an NWR pin.

5. The addressing type of asynchronous divider as claimed in claim 1, wherein said pin is an NRD pin.

6. The addressing type of asynchronous divider as claimed in claim 1, wherein when the data transfer of said ALE pin collocates with the data transfer from said bus, said data is an address.

7. The addressing type of asynchronous divider as claimed in claim 1, wherein when the data transfer of said NWR pin collocates with the data transfer from said bus, said data is the data which will transfer to said addressing type of asynchronous divider.

8. The addressing type of asynchronous divider as claimed in claim 1, wherein when the data transfer of said NWR pin collocates with the data transfer from said bus, said data is the data which will output from said addressing type of asynchronous divider.
